(19) United States
(12) Patent Application Publication
(10) Pub. No.: US 2007/0255754 A1
(43) Pub. Date: Nov. 1, 2007

(54) Recording, generation, storage and visual presentation of user activity metadata for web page documents

(76) Inventor: James Gheel, Belfast (GB)

Correspondence Address: Brake Hughes PLC;C/O Intellevate, P.O. Box 52050, Minneapolis, MN, 55402, US

(21) Appl. No.: 11/413,229

(22) Filed: Apr. 28, 2006

(51) Int. Cl. G06F 17/00

(52) U.S. Cl. 707/104.1

(57) ABSTRACT

Activity metadata associated with a user's interaction with online content is collected and associated with the online content. The activity metadata is stored, and the online content is located based on at least some of the activity metadata.

### TECHNICAL FIELD

This description relates to managing online content and, in particular, to the recording, storage, and presentation of user activity metadata for online content.

### BACKGROUND

The amount of electronic content available to users of computer systems, including documents and other content available through the Internet, continues to increase each year. However, the great benefit of increasing amounts of information available through the Internet, Intranets, and other computer networks can be reduced if users struggle with information overload and with locating the particular information they seek.

The success of Internet search engines, such as Google and Yahoo, is based largely on indexing of the electronic content that is searched by a user and on the sophisticated use of information in links between web pages. Highly effective algorithms have been devised to assess the level of importance the World Wide Web collectively attaches to a particular site or page. However, comparatively little research has focused on the importance a particular web site or web page has for an individual user.

Nevertheless, there is strong evidence that web page revisitation is a prevalent behavior when accessing online content, and that users attach unique importance to particular web pages or to other electronic content that they revisit. Despite this, textual query-based in standard search engines have difficulty locating pages that have been previously visited by a user. If a user enters a search query and then follows several links from among the links returned by the query to find a page of particular interest, then if a user later enters the same query in an attempt to find the same page, the user might follow a different set of links that take him further away from the desired page and perhaps even away from the topic he was browsing.

While bookmarks are simple and effective for marking pages of particular interest to a user, they can be somewhat cumbersome to manage and keep up-to-date. Address-bar histories and auto-complete functions perform a similar finction, but generally are automatically maintained by the browser and therefore do not distinguish electronic content by its level of importance to the user.

### SUMMARY

Internet users frequently revisit electronic content (e.g., web pages, documents, text, graphic, audio, and video files) that are of particular relevance to them. They also tend to have such electronic content open (e.g., a web page displayed on the users display screen) and interact with them for longer periods than other electronic content. In contrast, the usage behavior of infrequently accessed content will be different, but this content may be equally important at some point in the future. By recording electronic content access frequency and activity metadata that is based on user interactions with the content, it is possible to infer the importance the user attaches to any given content. Activity metadata, access history metadata, and document content can be stored in a local repository, which can help the user remember and quickly retrieve documents of high interest that the user has accessed in the past, particularly those that may not have been accessed frequently or have been accessed some time ago.

In a first general aspect, activity metadata associated with a user's interaction with online content is collected and associated with the online content. The activity metadata is stored, and the online content is located based on at least some of the activity metadata.

In another general aspect, an apparatus includes a machine-readable storage medium having executable-instructions stored thereon, and the instructions include an executable code segment for causing a processor to collect activity metadata associated with a user's interaction with online content and an executable code segment for causing a processor to associate the activity metadata with the online content. The instructions also include an executable code segment for causing a memory to store the activity metadata and an executable code segment for causing a processor to locate the online content based on at least some of the activity metadata.

In another general aspect, a system for locating online content includes a metadata collection engine, a memory, and a content retrieval engine. The metadata collection engine is operable for collecting activity metadata associated with a user's interaction with online content and associating the activity metadata with the online content. The memory is configured for storing the activity metadata. The content retrieval engine operable for locating the online content based on at least some of the activity metadata stored in the memory.

### BRIEF DESCRIPTION OF THE DRAWINGS

FIG. 1 is a schematic block diagram of a system for recording, storing, and presenting user activity metadata associated with online content with which the user interacts.

FIG. 2 is a screen shot of a user interface through which a user interacts with online content and which also can display user activity metadata about the online content.

FIG. 3 is a screen shot of a user interface for presenting information about a series of online content with which a user has interacted in the past along in chronological order, with activity metadata about the content.

FIG. 4 is a screen shot of a user interface for locating desired online content from a series of online content based on a number of metadata filter parameters.

FIG. 5 is a screen shot of a user interface for locating online content from a series of online content based on a query of the content itself or comments added by the user on the content.

FIG. 6 is flow chart of a process for extracting and/or generating activity metadata associated with a user's interaction with online content based on a the user's use of the content and locating the online content based on at least some of the activity metadata.

### DETAILED DESCRIPTION

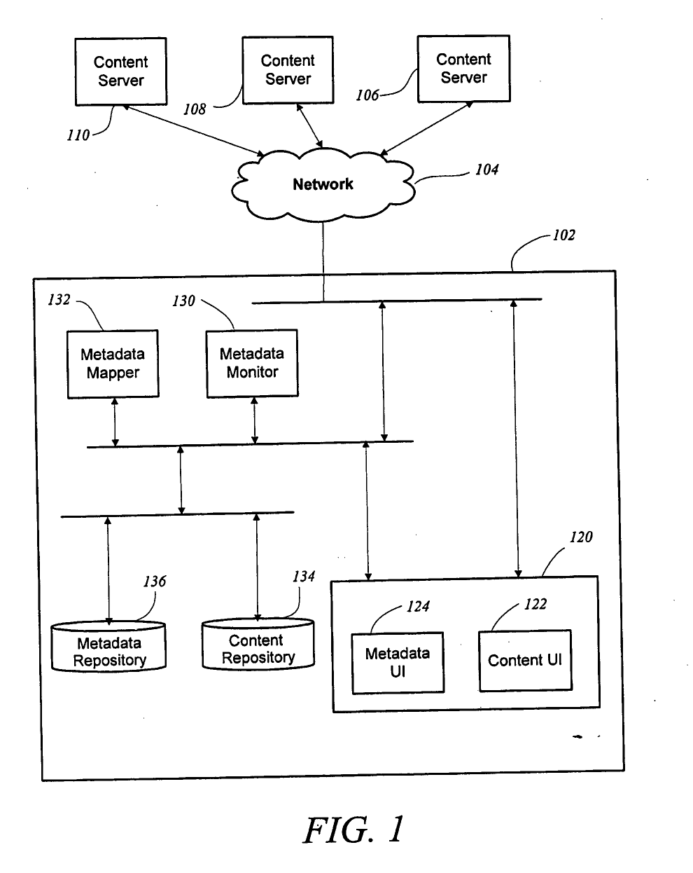

FIG. 1 is a schematic block diagram of a system for recording, storing, and presenting user activity metadata associated with online content with which the user interacts. A system 102 can receive online content through a network 104 from a content server 106, 108, or 110. For example, the system 102 can be a client system in a client-server architecture that receives online content from a number of servers. In one implementation, the network can be the Internet, an Intranet, or another computer network, and the servers 106, 108, and 110 can be web servers that serve web pages and associated online content (e.g., HTML content, and other textual, audio, and video files). In another implementation, the system 102 can be a sub-system of a larger system (e.g., a personal computer system, a personal digital assistant (PDA), a smart phone, a music or video player) that contains content that can be accessed by the system 102. For example, the system 102 can be a music player connected to one or more storage units from which it receives audio files that are played for a user.

The online content received by the system 102 is presented to a user through a user interface 120, which includes a content user interface 122 for presenting the content and a metadata user interface 124 for presenting metadata associated with the content, as explained in more detail herein. For example, the user interface 120 can be a browser (e.g., Internet Explorer, Mozilla Firefox, or Netscape Navigator) for displaying the content and the metadata. In another implementation the interface could be a display screen of a music player, smart phone, or PDA along with an amplifier and a speaker for playing audio file content.

Content presented to the user is also monitored by a metadata monitor engine 130 that extracts metadata associated with the content for storage and later use by the user. The metadata monitor engine 130 can be built into a browser that provides the user interface 120 or can be added as an extension to the browser. For example, the metadata monitor engine 130 can be a Java-based extension to Mozilla Firefox or Netscape Navigator, or can be an ActiveX control added to Internet Explorer.

As the system 102 receives online content and the user interacts with the content, the metadata monitor 130 can generate metadata associated with the user's interaction or activity with the content (“activity metadata” or “extrinsic metadata”) as well as extract metadata associated with the content itself (“intrinsic metadata”). For example, a web page or document accessible through the Internet contains metadata that is both visible to the user when reading the page or document and also by way of embedded tags that are not intended to be read directly as content. Furthermore, metadata exists that is not immediately evident from the actual document contents.

Examples of visible or intrinsic metadata include the web page's title, subject, and section headings, which provide a direct representation of the web page's topic and domain. Within the web page, the author may include as tags his name, company, keywords, and an expiry date for reference purposes, all of which are not immediately visible to the user. These metadata fields are also typically created by the author(s) of the web page and can be considered as manually determined metadata. Other intrinsic metadata that generally is not defined by tags within the code for the page include the location at which the web page is stored and can be retrieved from (e.g., a uniform resource locator (URL) if the page is located on the Internet), the size of the web page (i.e., as measured in bytes, paragraphs, viewable pages, etc), security information, a number of images, and a number of links. These intrinsic metadata can be considered as automatically generated metadata because the metadata information can be automatically generated from the web page content. Thus, when the online content is retrieved by the system 102 and presented to the user, the metadata monitor 130 can extract intrinsic metadata from metadata tags embedded in the content and can generate metadata associated with static characteristics of the content.

Metadata can also be generated based on the user's association or activity with the content. In one implementation, if the user retrieves a web page from the Internet for viewing, the metadata monitor 130 can maintain a history of the usage of that web page, and the history of usage can be used to generate activity metadata. For example, metadata concerning the amount of scrolling within a web page, the number of times the user clicks on links in the web page, and the amount of information entered into the web page can be generated automatically by the metadata monitor 130. If the user enters comments about the web page locally, such comments also can be maintained as metadata associated with the web page. In addition, the metadata monitor 130 can monitor the number of times the web page has been accessed and the date and time of the last access.

Thus, metadata can be categorized as intrinsic metadata that exists at the time of the web page's creation, i.e., intrinsic metadata that belongs as part of the web page implicitly, or as extrinsic metadata that is generated through the user's activity and interactions with of the content and potential local modifications and additions to the content. Some examples of intrinsic metadata include the web page's title, author, category, and the company name, keywords associated with the page (e.g., as metadata tags), the expiry date of the page, the URL at which the page is stored, the size of the page, the number of images in the page, and the number of links in the page. Some examples of extrinsic metadata include the user-generated comments or highlighting on the web page, the number of times the page has been accessed by the user, the date and time of last access to the page by the user, the location at which the user accessed the page (e.g., if the page is accessed through a portable device that includes a location-identifying service, such as a global positioning services, then the user's location during access to online content can be identified; alternatively the IP address from which the user accesses the content can identify the user's location), the number of local revisions to the page, the number of times the user has clicked on the page, the amount of scrolling through the page performed by the user, and the amount of text entered into the page (e.g., when filling out a web-based form).

The intrinsic metadata are static elements, and generally do not change unless the author specifically modifies the web page to create a new version of the page. Correspondingly, extrinsic metadata generally are dynamic elements, and change as the web page is used and updated locally by a user. Some extrinsic metadata can be automatically generated (e.g., metadata about the number of times the user has clicked on links in the web page), and some metadata can be manually determined (e.g., metadata about when the user enters a comment on the web page), and activity metadata can be automatically or manually determined (e.g., metadata about the amount of scrolling in the web page, the amount of information entered into the page, and the time the user has opened and/or focused on the web page).

The above-described metadata typology categorizes metadata from the perspective of a user's actions and needs but also draws on other metadata classifications and frameworks. For example, the Dublin Core Metadata Element Set described in ISO Standard 15836-2003 (February 2003) and in NISO Standard Z39.85-2001 (September 2001) is a simple 15-element classification developed to facilitate discovery of electronic resources and can be used by the metadata monitor to extract metadata from the online content. The 15 elements (i.e., Title, Creator, Subject, Description, Publisher, Contributor, Date, Type, Format, Identifier, Source, Language, Relation, Coverage, and Rights) have commonly understood semantics that represent what can function roughly as a catalogue card for electronic resources.

Other classifications, such at the classification presented in Boll, S., Klas, W. and Sheth, A., “Overview on Using Metadata to Manage Multimedia Data,” in Sheth and Klas, eds., Multimedia Data Management—Using Metadata to Integrate and Apply Digital Media, McGraw-Hill 1998, can be used to classify various types of media other than text-only web pages and can take into consideration those actions that may be performed to find and access multimedia information.

The extrinsic metadata about the user's activity with online content can provide information about the value of the online content to the user or can aid in locating the content at a later time. For example, the number of times a web page is viewed or opened can provide a valuable indicator of the webpage's importance to a user, e.g., indicating that the web page is a perceived authority on some topic, or is a highly reliable source of information. However, if the time spent on a page is usually very brief, then the web page is probably only a link to a more useful page. The metadata monitor 130 can generate this metadata about the number of times content is viewed and the duration of interaction with the content for later use. In another example, recalling even approximately the day or time the web page was accessed or where the user was at the time of access is often a major part of how a person remembers the web page. Thus, the metadata monitor 130 can generate activity metadata about when or from where a user accessed online content with the content and can associate the metadata with the content.

The size of a web page is another piece of information that can be used to evaluate the importance of a webpage to a user. The size (as measured in bytes) of a web page will influence the amount of time required to read the page. So too, a web page that includes a relatively large amount of text and fewer images will require the user to read more content per page view. When online content is loaded and presented to a user, the content can be parsed to determine the size of the web page (e.g., its size in bytes, paragraphs, characters, viewable pages, or images), and this information can be stored as metadata associated with the content. In one implementation, when a web page is presented to the user the metadata monitor 130 can check the HTML code of a web page for malformed HTML code and then reformat the web page to allow for Document Object Model (DOM) parsing of the web page to determine such intrinsic metadata about the page, such as its size and the number of hyperlinks in the web page.

When a user revisits a web page, the metadata monitor 130 can determine automatically if the web page has changed and the amount of change since the user's most recent previous view of the web page. Subsequently, this metadata can be used as an indicator of past change frequency and the quantity of the change in the web page. Also, the metadata monitor 130 can monitor the amount of scrolling by the user in a web page as an indication of the user's attentiveness to a web page. Similarly, in a browser with a tabbed user interface, repeatedly clicking to a certain tab indicates a high level of relevance to a task or subject of interest. The duration of a web page being open, taking into account whether it is in focus (i.e., whether it is opened and displayed to the user rather than minimized) can indicate the importance of the web page to the user's task and the quality of the web page's content. Additionally, a user taking information from a web page (e.g., by copying and pasting the information) indicates another level of the web page's relevance to the user. Conversely, if a user is required to enter information into a form on a web page, for example in an information request or in a forum, being able to recall this text and interaction with the web page can help relocate the web page at a later time. Also, usage of hyperlinks can represent the user's interaction with the web page. For example, the main value of a “hub” web page is as a set of pointers to a chosen topic. The number of times links are clicked in the web page therefore indicates something of that page's worth to the user. The short duration on screen of a sequence of web pages may suggest relevance to a target web page in that succession of links. Being able to recreate the steps made in a browsing trail and visually showing this at another point in time can mimic the path in a user's long-term memory, thereby rekindling the user's ability to remember and find a particular web page and related web pages. Such activity metadata about the user's active interaction with online content can be monitored by the metadata monitor 130.

The activity metadata associated with the user's interaction with online content can be mapped to the content itself by a metadata mapping engine 132. The metadata can be stored (e.g., in an XML document) in a metadata repository 136, while the associated online content presented to the user can be stored in a content repository 134 for later retrieval. Storing the online content in the repository 134 when the content is presented to the user allows the user later to locate the information that he viewed even if the content contained in a URL for the content has changed.

The contents of an exemplary XML file shown below include metadata for an individual web page, which are either extracted from the web page's intrinsic metadata (e.g., “keywords”), generated from analysis of the web page (e.g., “linkcount”), or generated from an analysis of the user's activity on the web page (e.g., “usagedurationfocused”).

<?xml version=“1.0” encoding=“UTF-8” ?>
<document>

<metadata>

<title>Google</title>
<author />
<subject />
<companyname />
<expirydate />
<citation />
<creationdate />
<pagecount>1</pagecount>
<paragraphcount>1</paragraphcount>
<headingcount>0</headingcount>
<annotations />

<comments>

<![CDATA[ Useful start page ]]>

</comments>

<highlighting />
<keywords />
<description />
<size>2888</size>
<imagecount>1</imagecount>
<imageset />
<thumbnail />

<uri>

<![CDATA[ http://www.google.co.uk/ ]]>

</uri>

<linkcount>12</linkcount>
<linkset />
<documenttype />
<relevance />
<accesscount>105</accesscount>
<lastaccesstime>2005.10.26 15:46:53</lastaccesstime>
<revisioncount>82</revisioncount>
<lastupdatetime />
<mouseactivity />
<scrollingactivity>78</scrollingactivity>
<clickcount>179</clickcount>
<linkclickcount>20</linkclickcount>
<usagedurationfocused>128229</usagedurationfocused>
<usagedurationunfocused />
<copytextfrom />
<dataentry>788</dataentry>
<cpuactivity />
<distancetonextdoc />
</metadata>

</document>

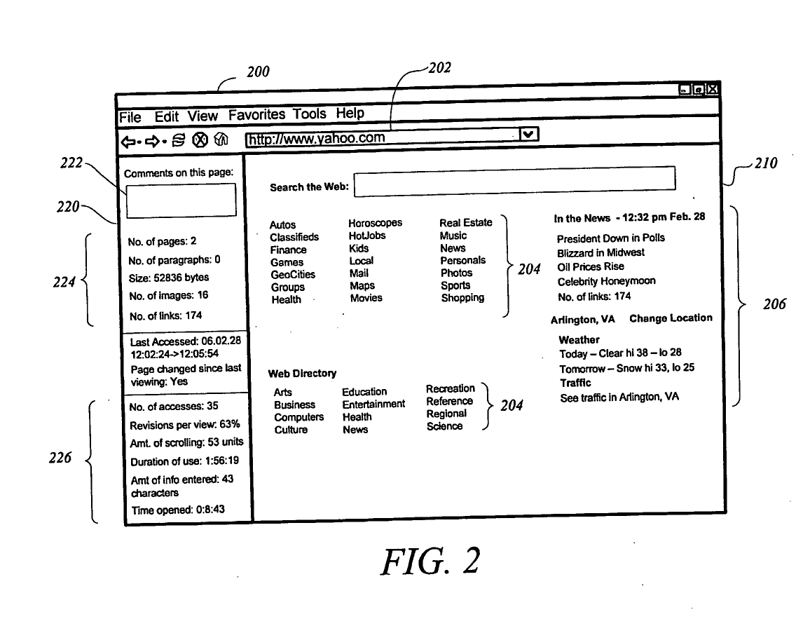

FIG. 2 is a screen shot of a user interface 200 through which a user interacts with online content and which also can display user activity metadata about the online content. The user interface 200 can be provided by a browser that can locate online content by entering a URL 202 that points to the content. The user interface 200 can include a content display window 210 of content that includes a number of hyperlinks 204 that point to general categories of information and customized links 206 that point to information of particular interest to a user. The customized links can provide information about weather in a geographic region of interest to the user, news about particular topics, and the like. The user interface 200 can also include a metadata display window 220 that includes metadata information about the online content and the user's interaction with the online content. The metadata display window 220 can be presented as a sidebar in the browser, which the user has the option to turn on or off. The metadata display window 220 can provide a window 222 in which user-generated comments about the content can be entered and displayed. Such content can supplement the intrinsic metadata associated with the content (e.g., keywords) to provide user-specific metadata. For example, the user might enter a comment that the content is relevant to a research project he is working on or that the content would be of interest to a colleague or that the user was speaking with a particular person at the moment the page was accessed.

The metadata display window 220 also can display information 224 about the intrinsic metadata associated with the online content. For example, such information can include information about size of the content file(s) and the number of pages, links, images, and paragraphs in the online content presented to the user. The metadata display window 220 can also present extrinsic metadata to the user about the user's interaction with the online content. Such information can include, for example, when the content was last accessed, whether the content has changed since the last access, the number of times the content has been accessed by the viewer, the frequency with which content at the URL is revised (which can be quantified in terms of a ratio between the number of times the page has been revised or updated and the number of times the user has accessed the page), the amount of scrolling the user has performed in the content, the total time the page has been opened and/or in focus, and the amount of information (e.g., the number of alphanumeric characters) that have been entered into the content.

After activity metadata have been generated, associated with the online content, and stored, they can be used to visualize and locate the content itself. Thus, the activity metadata can be presented in a framework that can underpin visualization techniques dedicated to the perceptual characteristics of users during the management of electronic web pages.

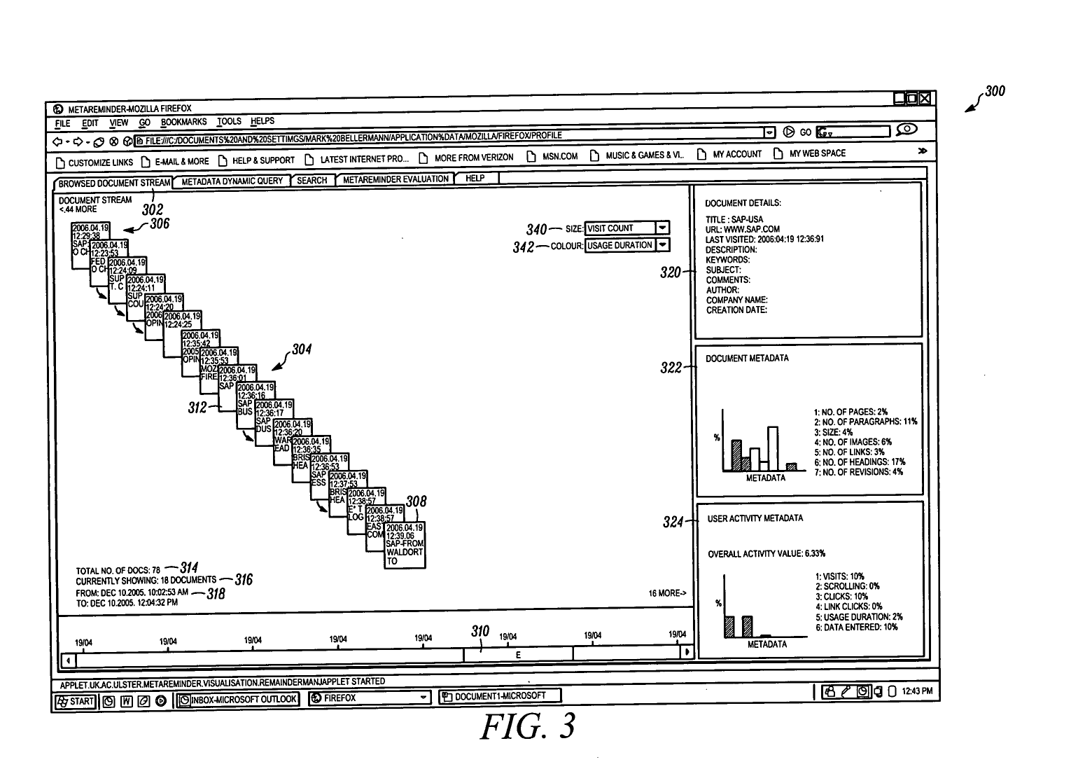

FIG. 3 is a screen shot of a user interface 300 for presenting information about a series of online content (e.g., web pages) with which a user has interacted in the past, along with activity metadata about the content. The user interface 300 can be presented to the user by a browser and can include a tab 302 for selecting the series of online content for display to the user. The series of online content viewed by the user can be presented graphically to the user in a time-ordered stream of documents 304, for example, in a graphical user interface known as a Lifestream. The tail 306 of the stream contains representations of web pages viewed relatively long ago, and as the representations of web pages move away from the tail and toward the head of the stream 308, the stream contains representations of more recent web pages. A user can scroll through the stream 304 by moving a slider ends of a slider bar 310 to select a head and tail of the stream that correspond to particular times.

At the bottom left of the document stream 304, some contextual information about the stream 304 is displayed, such as the total number of browsed web pages 314, the number of web pages presently on display in the stream 316, and the dates these displayed web pages range from and to 318. At the top right of the stream 304, are two boxes for selecting the context in which items of the stream are displayed. The first box allows the user to display icons representing web pages in the stream in terms of their size based on a particular aspect of their metadata associated with the items of the stream. For example, by selecting “Visit Count,” a web page that has been viewed in the browser many times will be shown as larger icon 312 than the icon of a web page that has been viewed only a small number of times.

Similarly, the color box 342 causes icons in the stream to be displayed in varying colors depending on the metadata selected in the second box 342. For example, if “Usage Duration,” is selected then icons associated with web pages that have been have viewed for a relatively long period of time will be shown in the stream in a dark red color while icons for web pages that have been viewed for a shorter period of time will be displayed in a light blue color. Other metadata parameters (e.g., the number of pages, paragraphs, images, links, headings, revisions in the web page, the size of the web page, the amount of scrolling, clicking, clicking on links, or information entered in the web page) can be selected from the boxes 340 and 342 for selectively displaying the size, color, or other graphical information about the icons 312 in the stream 304.

The contents of an exemplary XML file shown below show metadata (stored as XML content) that are built up over time as the user visits and views various web pages. Usage of a web browser is captured as a session. The session in turn contains a series of time-related web page documents that the user views. An individual web page document might have been referred by a previously viewed Web page document by way of an embedded hyperlink, which is also captured in the XML document. The contents of the XML file are then used to display the chronological order of accessed web pages shown in FIG. 3.

<?xml version=“1.0” encoding=“UTF-8” ?>
<document>

<browsingtrail>

<session>

<startdate>2005.08.15</startdate>
<starttime>14:59:22</starttime>
<trail>

<webdoc>

<date>2005.08.15</date>

<time>15:09:41</time>

<URI>http://www.google.co.uk/</URI>
<referrer />

</webdoc>

<webdoc>

<date>2005.08.15</date>

<time>15:11:12</time>

<URI>http://www.globus.org/</URI>

<referrer />

</webdoc>

<webdoc>

<date>2005.08.15</date>

<time>15:12:22</time>

<URI>http://www.globus.org/alliance/news/</URI>

<referrer>http://www.globus.org/</referrer>

</webdoc>

</trail>

</session>
<session>

<startdate>2005.08.15</startdate>
<starttime>15:39:05</starttime>
<trail>
<webdoc>

<date>2005.08.15</date>

<time>15:49:41</time>
<URI>http://www.google.co.uk/</URI>

<referrer />

</webdoc>

</trail>

</session>
<session>

<startdate>2005.08.16</startdate>
<starttime>14:18:35</starttime>

<trail>

<webdoc>

<URI>http://www.google.co.uk/</URI>
<referrer />

</webdoc>

<webdoc>

<startdate>2005.08.16</startdate>
<starttime>14:19:05</starttime>
<URI>http://www.google.co.uk/imghp?hl=en&tab=wi&q=</URI>
<referrer>http://www.google.co.uk/</referrer>

</webdoc>

<webdoc>

<startdate>2005.08.16</startdate>

<starttime>14:38:58</starttime>

<URI>http://www.google.co.uk/imghp?hl=en&tab=wi&q=</URI>
<referrer>http://www.google.co.uk/</referrer>

</webdoc>

</trail>

</session>

Each icon 312 in the steam 304 displays some information about the online content associated with the icon 312. For example, the icon 312 can display the time at which the content was last accessed and the title of the content. Additional information about the content can be display in a content window 320, which can display, for example, information about the title, URL, description, keywords, subject, comments, author, company name, creation date, and time of last visit associated with the content. Double-clicking on an icon 312 in the document stream 304 will open the web page associated with the icon in the browser.

Another window 322 can present information about the intrinsic metadata associated with the content represented by the icon 312 over which a user scrolls. For example, information about the size of the content, revisions to the content, and the number of pages, paragraphs, links, images, and headings in the content can be displayed in the window 322. The intrinsic metadata window 322 also includes a bar chart of the structure of the web paged that was accessed by the user and includes information about, for example, the number of images in the document, the number of pages on screen, and the size of the document. These values can be shown as absolute values or as a percentage of the maximum value found and any of the web pages accessed by the user browsed. For example, if the maximum number of links of any web page accessed by the user is 100, and the currently highlighted web page in the stream has 10 links, then the value in the bar chart will be 10%.

Still another window 324 can present information about activity metadata associated with the content represented by the icon 312 over which a user scrolls. For example, information about the number of times the content is accessed, the amount of scrolling in the web page, the number of total click and the number of clicks on links in the web page, the amount of data entered and the usage duration of the content scan be displayed in the window 324. When the user scrolls over a representation 312 of the content, the additional information about the content, the intrinsic metadata, and the activity metadata can appear automatically in the windows 320, 322, and 324. As with the intrinsic metadata window 322, these values are shown as a percentage of the maximum value of any web pages that have been browsed. For example, if the maximum number of visits made to any web page accessed by the user is 50, and the currently highlighted page in the stream has been browsed 25 times, then the value in the bar chart will be 50%.

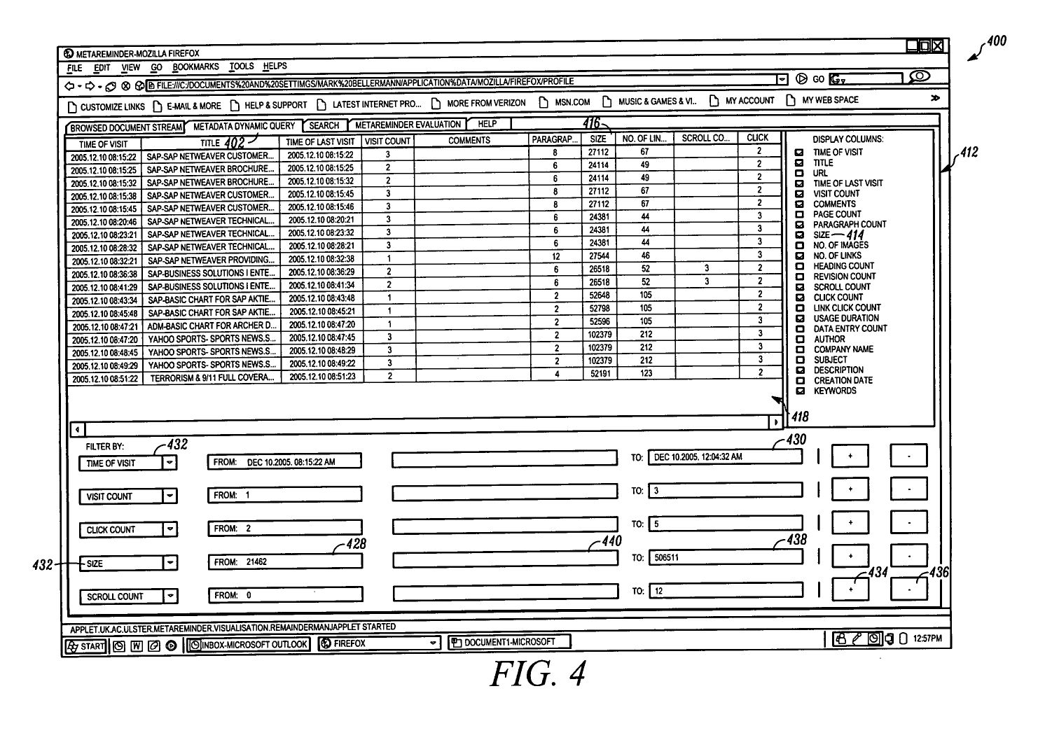

FIG. 4 is a screen shot of a user interface for locating desired online content from a series of online content based on a number of filter parameters. The user interface 400 can be presented to the user by a browser and can include a tab 402 for displaying the interface for performing a dynamic query on the series of online content.

When the interface 400 is initially loaded, metadata information about all the web pages in the chronological order of accessed web pages 304 is loaded for presentation to the user in the interface 300. Subsets of the metadata information can be selected for display by clicking in a window 412 on particular radio buttons corresponding to particular metadata information. For example, the radio buttons can be used to select or de-select for display metadata information about the time a web page was visited, the title, URL, author, company name, subject description, creation date, or keywords associated with the web page, the time of the last access of the web page, the number of accesses of the web page, comments entered by the user about the web page, the number of pages, paragraphs, links, images, headings, revisions in the web page, the size of the web page, the amount of scrolling, clicking, clicking on links, or entry of data the user has performed on the web page, and the duration for which the user used the web page. Selecting a particular radio button 414 in the window 412 causes a corresponding column 416 in a main window 418 of the interface 400 to be displayed, which contains metadata information corresponding to the name of the selected radio button 414.

A dynamic query based on intrinsic and extrinsic metadata (including activity metadata) to locate online content that has been previously accessed by the user can be performed by using metadata information to filter the web pages displayed in the main window 418 of the interface 400. In one implementation, the query can be performed by limited the display of web pages in the main window 418 to those pages that satisfy certain criteria given by ranges of metadata values defined in a query window 430. The query window 430 allows the user to select one or more metadata parameters for filtering from drop down lists in boxes 432. Additional parameters can be added by selecting an “Add” button 434, and parameters can be removed by selecting a “Remove” button 436.

For a selected metadata parameter used for the query (e.g., the size of the web page in bytes), a range of metadata values for the parameter can be defined by entering a minimum and maximum value for the parameter in text fields 438 or by using a slider bar 440 to select a sub-range of values from the global minimum and maximum values that exist in the content of the entire chronological order of accessed web pages of content that the user has accessed.

Only content whose metadata values satisfy the criteria defined in the query window 430 are displayed in the main window 418. The results of the selected are combined together, and the table of web pages in the main window 418 is filtered by each selected range of metadata in succession. For example, to locate a web page or web pages accessed long ago, with a large size, and in which a large amount of text was entered, the “Time of visit,” “Size,” and “Data Entry Count” filters would be selected in the query window 430, and the ends of the slider bars for each filter would be positioned accordingly.

After the results of the query are returned and presented to the user, double-clicking on information associated with the online content displayed in the main window can cause online content to be loaded from the content repository 134 and displayed to the user in a user interface 120 as it existed when the user originally accessed the content. By right-clicking on information associated with the online content a popup menu will be shown. Selecting the first item in the popup will cause an icon for the content to be displayed to the user in a chronological order of accessed web pages (e.g., as shown in FIG. 3), such that the user is presented with the content within the context of the other online content the user accessed within a close period of time of accessing the selected content. Selecting the second item in the popup menu will cause the most recent occurrence of the content in the table to be shown in the chronological order of accessed web pages, and selecting a third item in the popup menu will cause icons for all the occurrences of the content from among the accessed web pages to be displayed to the user in a chronological order.

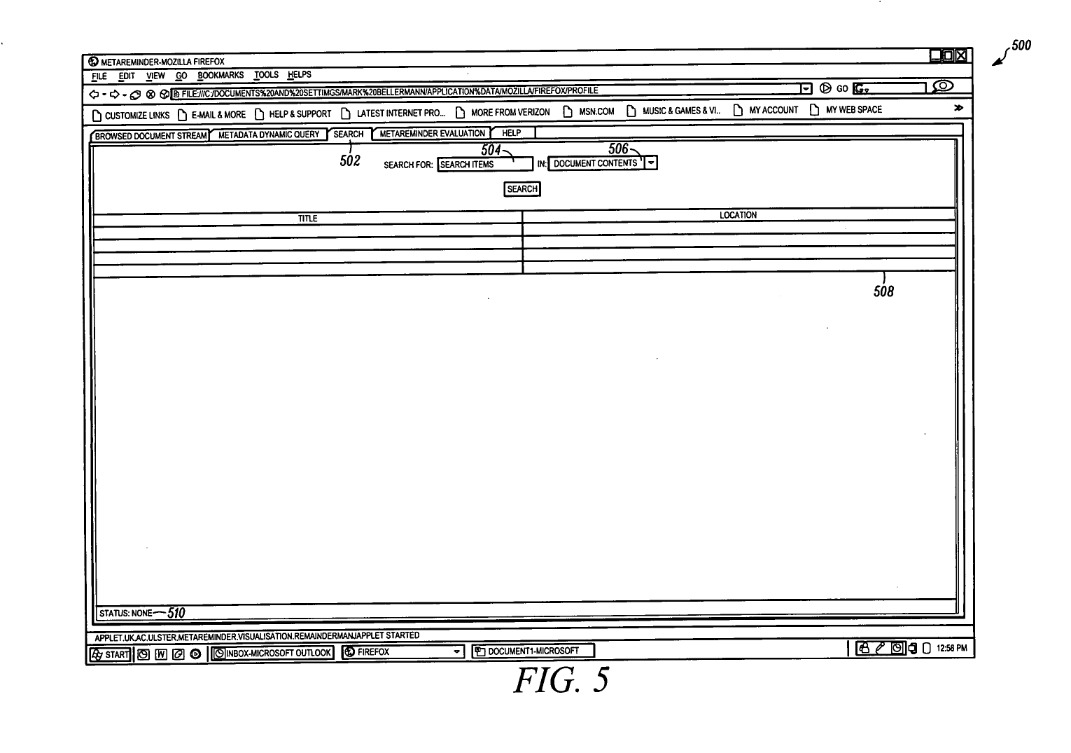

FIG. 5 is a screen shot of a user interface 500 for locating online content from a series of online content based on a query and can be displayed to the user when a “Search” tab 502 is selected. The interface allows a user to search online content that has been accessed by the user. The user can search either the content itself or the comments on the content that were entered by the user when accessing the content. The search keywords can be entered in a textbox 504, and where the search is performed can be selected in a drop down box 506. Standard search algorithms are used to locate previously-accessed content based on the search parameters entered in the textbox 504.

The results of the search are shown in the table 508 below the search keywords and show the Title and Location of the web page that contains the search keyword(s) or the web page associated with the comments that contain the search keyword(s). If the search is in the comments, then the comments are also shown in the results. Below the table, the total number of results found is shown in a status bar 510.

Double-clicking on a row in the table of search results 508 will cause online content to be loaded from the content repository 134 and displayed to the user in a user interface 120 as it existed when the user originally accessed the content. By right-clicking on information associated with the online content a popup menu will be shown. Selecting the first item in the popup will cause an icon for the content to be displayed to the user in a chronological order of accessed web pages (e.g., as shown in FIG. 3), such that the user is presented with the content within the context of other online content the user accessed within a close period of time of accessing the selected content. Selecting the second item in the popup menu will cause the most recent occurrence of the content in the table to be shown in the chronological order of accessed web pages, and selecting a third item in the popup menu will cause icons for all the occurrences of the content from among the accessed web pages to be displayed to the user in a chronological order.

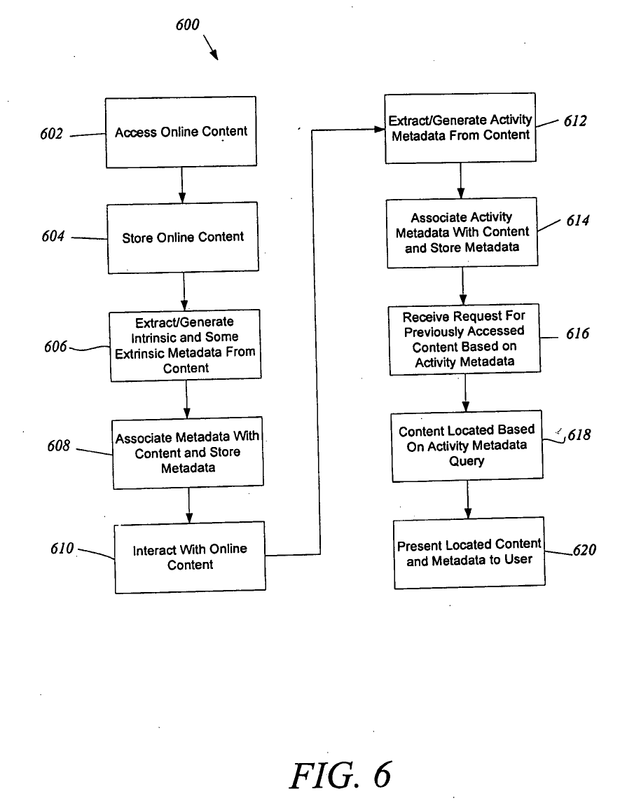

FIG. 6 is flow chart of a process 600 for collecting activity metadata associated with a user's interaction with online content and locating the online content based on at least some of the activity metadata.

The process begins when a user accesses online content, for example a web page (step 602). When the online content is accessed custom browser code can be invoked in an extension to the browser and cause a copy or representation of the online content to be stored locally (step 604). For example, the code can cause the currently viewed web page to be stored exactly as it has been downloaded to the browser.

Next, the online content is formatted for parsing. For example, in the case of a HTML-based web page, the HTML code of the web page is checked for malformed HTML and then re-formatted to allow for Document Object Model (DOM) parsing. Then, non-activity metadata that is relevant to the document, such as title, description, number of links, and size is extracted and/or generated from the content (step 606).

Interactions of the user with the content (step 610) are monitored and activity data are generated and/or extracted and associated with the content based on the user's interactions with the content (step 612). The metadata generated and extracted in steps 606 and 612 are combined in one complete XML document and mapped in a one-to-one relationship to the original HTML document of the online content, and the XML document is stored (step 614).

When a user wishes to retrieve previously viewed online content, a tool within the browser functionality is activated and a locally stored web page containing custom code and a custom user interface is displayed within the browser for receiving a request for the previously-accessed content based on activity metadata (step 616). The custom user interface and custom code and be used to locate content based on activity metadata (step 618). The custom code and user interface can then present the located content to the user and also can show a visual representation the user's history of online content navigation, based on the activity of the user when engaged with the web page document (i.e., the activity metadata), in addition to embedded document metadata and browser generated metadata (step 620).

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
collecting activity metadata associated with a user's interaction with online content;
associating the activity metadata with the online content;
storing the activity metadata; and
locating the online content based on at least some of the activity metadata.

2. The method of claim 1, wherein the online content comprises content accessible through a browser, the method further comprising:
locally storing the online content; and
wherein locating the online content comprises locating the online content within the locally stored online content.

3. The method of claim 1, wherein the activity metadata comprises data about the number of times a user has viewed the online content.

4. The method of claim 1, wherein the activity metadata comprises data about the amount of information entered by the user into the online content.

5. The method of claim 1, wherein the activity metadata comprises data about the amount of time the user viewed the online content.

6. The method of claim 1, wherein the activity metadata comprises data about the amount of time the online content has been opened by the user.

7. The method of claim 1, wherein the activity metadata comprises data about the amount of scrolling performed by a user within the online content.

8. The method of claim 1, wherein the activity metadata comprises data about the amount of data entered into the online content by the user.

9. The method of claim 1, wherein the activity metadata comprises a user-generated comment about the online content.

10. The method of claim 1, wherein locating the online content based on at least some of the activity metadata comprises:
receiving a user-defined query for the online content based on at least a portion of the activity metadata;
locating activity metadata specified by the query;
presenting information to the user, wherein the information allows the user to view the online content.

11. The method of claim 1, further comprising:
displaying the online content to the user; and
displaying at least some of the activity metadata to user.

12. The method of claim 1, further comprising displaying simultaneously the online content and at least some of the activity metadata.

13. The method of claim 1, further comprising:
collecting content metadata about the online content;
associating the content metadata with the activity metadata and with the online content;
storing content metadata; and
locating the online content based on at least some of the activity metadata and at least some of the content metadata.

14. An apparatus comprising a machine-readable storage medium having executable-instructions stored thereon, the instructions including:
an executable code segment for causing a processor to collect activity metadata associated with a user's interaction with online content;
an executable code segment for causing a processor to associate the activity metadata with the online content;
an executable code segment for causing a memory to store the activity metadata; and
an executable code segment for causing a processor to locate the online content based on at least some of the activity metadata.

15. A system for locating online content, the system comprising:
a metadata collection engine operable for collecting activity metadata associated with a user's interaction with online content and associating the activity metadata with the online content; and
a memory configured for storing the activity metadata; and
a content retrieval engine operable for locating the online content based on at least some of the activity metadata stored in the memory.

16. The system of claim 15, wherein the online content comprises content accessible through a browser, the system further comprising:
a memory configured for locally storing the online content; and
wherein the content retrieval engine is further operable for locating the online content within the locally stored online content.

17. The system of claim 15, wherein the activity metadata comprises data selected from the group consisting of data about a number of times a user has viewed the online content, data about an amount of information entered by the user into the online content, data about an amount of time the user viewed the online content, data about an amount of time the online content has been opened by the user, data about an amount of scrolling performed by a user within the online content, data about an amount of data entered into the online content by the user, and a user-generated comment about the online content.

18. The system of claim 15, the content retrieval engine is further operable for:
receiving a user-defined query for the online content based on at least a portion of the activity metadata;
locating activity metadata specified by the query within the activity metadata stored in the memory;
presenting information to the user, wherein the information allows the user to view the online content.

19. The system of claim 15, further comprising:
a display configured for simultaneously displaying the online content to the user and displaying at least some of the activity metadata to user.

20. The system of claim 15, wherein:
the metadata collection engine is further operable for collecting content metadata about the online content and associating the content metadata with the activity metadata and with the online content;
the memory is further configured for storing content metadata; and
the content retrieval engine is further configured for locating the online content based on at least some of the activity metadata and at least some of the content metadata.
